(19) United States
(12) Patent Application Publication
(10) Pub. No.: US 2003/0171932 A1
(43) Pub. Date: Sep. 11, 2003

(54) Speech recognition

(76) Inventors: Biing-Hwang Juang, Warren, NJ (US); Jialin Zhong, Berkeley Heights, NJ (US)

Correspondence Address: Eli Weiss, Esq., Cohen, Pontani, Lieberman & Pavane, Suite 1210, 551 Fifth Avenue, New York, NY, 10176, US

(21) Appl. No.: 10/092,876

(22) Filed: Mar. 7, 2002

(51) Int. Cl. G10L 21/06

(52) U.S. Cl. 704/276

(57) ABSTRACT

A method and apparatus for automatically controlling the operation of a speech recognition system without requiring unusual or unnatural activity of the speaker by passively determining if received sound is speech of the user before activating the speech recognition system. A video camera and microphone are located in a hand-held device. The video camera records a video image of the speaker's face, i.e., of speech articulators of the user such as the lips and/or mouth. The recorded characteristics of the articulators are analyzed to identify the sound that the articulators would be expected to make, as in “lip reading”. A microphone concurrently records the acoustic properties of received sound proximate the user. The recorded acoustic properties of the received sound are then compared to the characteristics of speech that would be expected to be generated by the recorded speech articulators to determine whether they match. If so, then the received sound is identified as having emanated from the user the speech recognition system is operated to perform speech recognition of the received sound.

### BACKGROUND OF THE INVENTION

1. Field of the Invention

The present invention relates to automatically identifying the presence of speech. More particularly, the invention is directed to methods and apparatus for automatically detecting and identifying received speech from a user of a speech recognition unit.

2. Description of the Related Art

Speech recognition systems are well known in the art and are being used with increasingly frequency in hand held devices such as the “Palm Pilot” or “Compaq iPAQ” to store, in verbal form, calendar data and contact information. Hand held devices are also being used as voice message recorders and/or communication devices to record a reminder message, make a telephone call, access remote information, and the like. For example, demonstrations in laboratories have shown that these devices can function as an IP phone to transmit speech via IP packets, and to access voice portals which support voice enabled services by utilizing automatic speech recognition systems. In these applications speech is normally the input source and, therefore, speech detection is essential.

One problem with current speech detection systems is their inability to distinguish relevant speech from irrelevant speech or sounds that are normally present or heard, either separately or in combination with relevant speech, such as passing background conversations. Currently, speech recognition systems normally require the user to mark the beginning and/or end of speech input by performing an indexing activity such as pushing a button, or saying a specific word or phrase, so that the system will know when to “listen” and when to “sleep”. Some of the various techniques used by humans to determine when speech is intended for them is to listen for the use of a specific word such as their name, or look for a visual clue such as the movements of a person's mouth in combination with detecting speech. To provide speech recognition systems with functions that are compatible with the way that humans normally function, some speech recognition units use a specific word or phrase (similar to the use of a persons name) to activate or “wake up” the speech recognition system and a “go to sleep” phrase to tell the speech recognition system to stop operating. Many speech recognition units use the more positive approach of requiring the user to depress a “talk” button to activate the system. These methods, however, have specific limitations. The use of “wake up” words or phases are often undetected and additional time is then required to return the speech recognition system on or off. Toggle-to-talk buttons require user proximity which undermines the advantage of operating without the need for physical contact with the speech recognition system.

Aside from the general need of reliability in speech activity detection, recognition of speech input to an automatic speech system can be adversely affected by background voices and environmental noise. To overcome this obstacle, a point and speak method has been proposed for use with a computer. With this system, before speaking the user points a stylus at a screen icon to alert the system that he is going to talk. This system however is not only inconvenient to the user, but the process that it uses is inherently unnatural.

Clearly, what is needed is a method and apparatus for using operating or employing a speech recognition system that avoids the shortcomings of current systems. In the present invention, human speech activity is automatically detected and processed in a passive manner so that no extra effort or unnatural activity is required by the user to activate the speech recognition system.

### SUMMARY OF THE INVENTION

The present invention provides methods and apparatus for automatically controlling the operation of a speech recognition system without requiring any unnatural movement or activity on the part of the speaker. As is apparent, people make various sounds that form the basis of all speech by controlling the shape and position of speech articulators such as the lips, mouth, tongue, teeth, etc. while passing air outwardly from the mouth. Controlled shapes of these articulators and their positions relative to each other determine the characteristics of the sound that is produced. The present invention identifies if received audio information is actually speech of the person that is using the speech recognition system before the system is turned on. In a hand held device, a video camera takes a video image of a speaker's face, specifically his speech articulators such as the lips and/or mouth shape. In a manner similar to “lip reading”, this information is analyzed to identify the sounds or words that such shape would make. At the same time, a microphone receives the sound that is actually produced. The characteristics of that sound are then compared to the sound that “should” result from the observed shape of the speech articulators to determine whether there is a match. If so, then the speech received is identified as emanating from the person in the video image, and the speech recognition system is activated to process the received sound.

For a better understanding of the invention, reference is made to the following description taken in conjunction with the accompanying drawing, and the scope of the invention will be pointed out by the appended claims.

Other objects and features of the present invention will become apparent from the following detailed description considered in conjunction with the accompanying drawings. It is It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram of an illustrative embodiment of a computer system adapted for speech recognition according to the present invention;

FIG. 2 is a block diagram of an embodiment of the invention wherein video and audio inputs are used to aid in the control of a speech recognition unit; and,

FIG. 3 is a flow chart depicting control of a speech recognition unit using video and verbal information in accordance with the teachings of the present invention.

### DETAILED DESCRIPTION OF THE PRESENTLY PREFERRED EMBODIMENTS

The present invention is broadly directed to methods and apparatus which automatically detect and determine if received speech is that of the user of the speech recognition system and, if so, for generating a signal to start the operation of the speech recognition system without requiring the speaker to first utter any activating control words or to depress or operate a start-stop button or switch. Thus, the occurrence of human speech is automatically detected and such detection is entirely transparent to the speaker. The method of the invention is preferably implemented in a digital computer based speech recognition system capable of recognizing speech data, and of at least temporarily storing recognized speech data in a memory. A typical speech recognition system receives speech as a collection or stream of speech data segments. As each speech data segment is vocalized by a user, the automated speech recognition system recognizes and stores a data element that corresponds to that speech data segment. In accordance with the present invention, as soon as speech is detected and is identified as being from the user, the speech recognition system is activated and remains so until speech from the user is no longer detected. No overt or conscious act on the part of the speaker is, therefore, required to activate and deactivate the system.

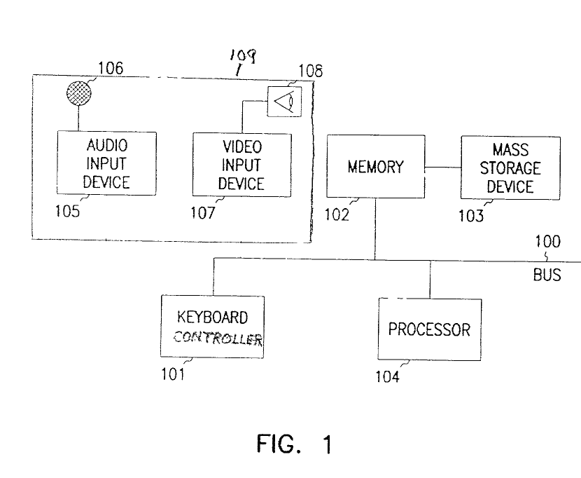

Referring to FIG. 1, there is illustrated a block diagram of an embodiment of the present invention. The speech recognition system is normally implemented in or incorporated within a computer system which comprises bus 100, keyboard controller 101, external memory 102, mass storage device 103 and processor 104. Bus 100 can be a single bus or a combination of multiple buses, and provides communication links between the various components of the computer system. Keyboard controller 101 may be a dedicated device or can reside in another component such as a bus controller or another controller such as a hand held device, i.e., a Palm Pilot or Compaq iPAQ. The keyboard controller accommodates coupling of a keyboard to the computer system and transmits signals from a keyboard to the computer system. If the keyboard is located or implemented in the hand held device, it may be coupled to the keyboard controller by infrared, radio waves or the like. Memory 102 stores information from mass storage device 102 and processor 104 for use by processor 104. Mass storage device 103 can be a hard disk drive, a floppy disk drive, a CD-ROM device, or a flash memory device. Processor 104 provides information to memory 102, and may be a microprocessor operable for decoding and executing a computer program such as an application program or operating system. An audio input device 105 is provided and includes a microphone 106 to receive sound and convert it to a digital form that can be processed by the system, and in particular, by processor 104. The audio input device is preferably located within the hand held device. A video input device 107, which includes a video camera 108 positioned to view a visual field, is also located in or on the hand held device. The video input device outputs a digital video signal that can be processed by processor 104.

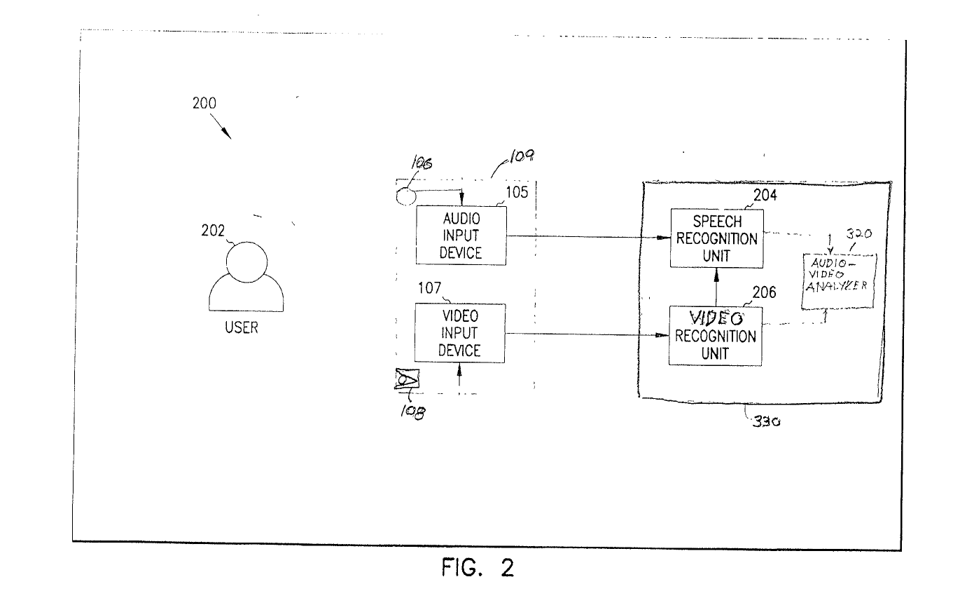

FIG. 2 depicts a block diagram of an exemplary speech recognition system 200 according to an embodiment of the invention. As shown in FIG. 2, a user 202 is positioned within the field of view of camera 108 and within the audio range of microphone 106 that are located in or otherwise associated with a hand held device 109. This positioning of the microphone and the camera normally results when a user picks up the hand held device and begins to speak. Audio input device 105 and video input device 107 respectively output digital information to a speech recognition unit 204 and a video recognition unit 206. Video recognition unit 206 provides an input to speech recognition unit 204, and the speech recognition unit and video recognition unit provide inputs to an audio-video analyzer 320. The video recognition unit 206, speech recognition unit 204 and audio-video analyzer 320 together form the user recognition unit 330.

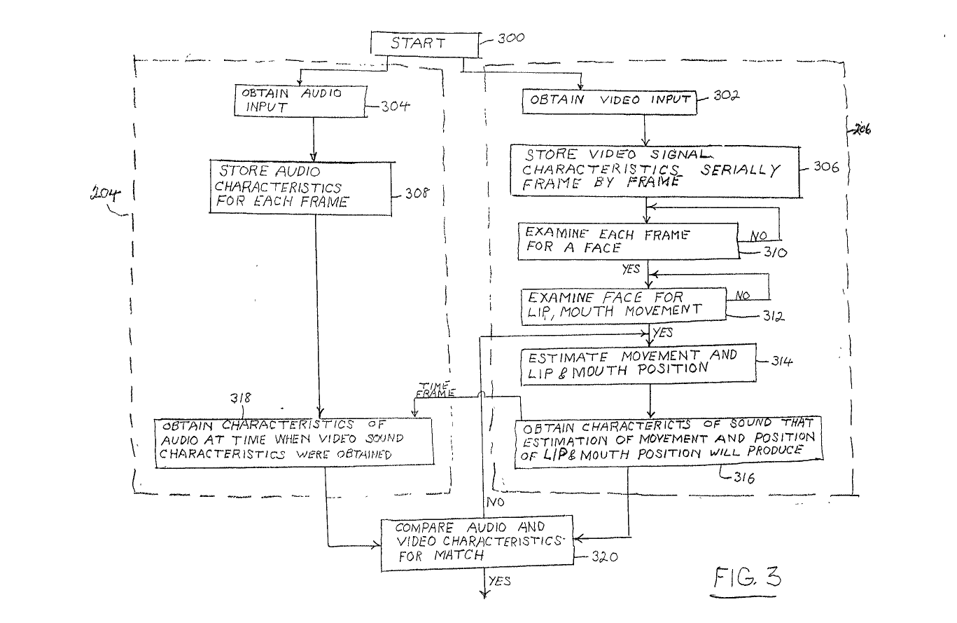

FIG. 3 is a flow chart illustrating the operation of user recognition unit 3. The inventive method begins at step 300 and proceeds to step 302 at which the video signal is received, frame by frame. The characteristics of the received video signal for each frame are obtained and serially stored, frame by frame, at step 306. At step 304 the audio signal is received and time indexed to synchronize the audio signal, frame by frame, to the video signal. Thus, for each frame of video information there is a corresponding “frame” of audio signal information, where the information in each of the two corresponding frames were obtained at the same time. The characteristics of the received audio signal are serially stored at step 308. At step 310, the frames of video information are examined, sequentially, frame by frame until a face is recognized or detected; an examination of that frame is then carried out, at step 312, to identify movement of the speech articulators such as motion or displacement of the lip, mouth and/or tongue. Upon detection that one or more of the speech articulators has moved or is moving, an estimate of that movement is made at step 314. Then, using the estimate of the motion and the position of the speech articulators, the characteristics of the sound (i.e., the speech) that such motion of the speech articulators is expected to produce are determined at step 316. The frame of video information used in step 316 to obtain the sound characteristics is identified and the frame of audio signal characteristics that corresponds in time with that video frame is selected for analysis. At step 318, the frame of audio signal characteristics which has been selected is analyzed and the characteristics of the received sound (i.e., the speech) stored in that frame are obtained. The characteristics of the actual sound reviewed and analyzed at step 318 from the frame of audio information is then compared, at step 320, with the estimated sound that the form of the speech articulators is expected to produce from step 316. If there is no match, an examination of the successive frames of video information continues. When there is a match, on the other hand, a signal is generated to indicate that the speech recognition system should begin operating, or to trigger such operation. Suitable time delays can be incorporated to maintain operation of the speech recognition system for a preset time interval while a search is carried out for another match of the video and audio information. If a match is found within the preset time interval, the speech recognition system continues to operate. If, however, another match is not found within the preset time interval, then the speech recognition system ceases operation.

There has accordingly been disclosed a method for inputting speech to a handheld device simultaneously using a microphone and a camera, where the microphone and camera are located on or in the handheld device. It should nevertheless be understood that the method herein disclosed can also be used with other devices, such as desktop computers or in IP telephony, that are equipped or associated with a microphone and camera. It is again noted that the inventive method is totally passive as it does not require that the user or others perform any unusual steps or other function in addition to the normal action of talking into the handheld or other device.

Although the invention has been described herein with respect to specific embodiments, it should be understood that these embodiments are exemplary only, and that it is contemplated that the described methods and apparatus of the invention can be varied widely while still maintaining the advantages of the invention. Thus, the disclosure should not be understood as limiting in any way the intended scope of the invention. In addition, as used herein, the term “unit” is intended to refer to a digital device that may, for example, take the form of a hardwired circuit, or software executing on a processor, or a combination thereof. For example, the units 204, 206, 208, 310, 312, 314, 316, 318, 320, may by illustrative example be implemented by software executing in processor 104, or all or some of the functionality of these components can be provided by hardware alone. Furthermore, as used herein, the term machine readable medium is intended to include, without limitation, a storage disk, CD-ROM, RAM or ROM memory, or an electronic signal propagating between components in a system or network.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of controlling the operation of a speech recognition device, comprising the steps of:
recording at least one frame of a video image of speech articulators of a user while the user is speaking;
recording acoustic properties of speech that occurs concurrent with the recording of the at least one video frame;
identifying acoustic properties of speech that would be expected to be generated by a condition of the speech articulators recorded in the at least one frame of the video image; and
comparing the identified acoustic properties of speech with the recorded acoustic properties to determine whether the speech of the recorded properties emanated from the user.

2. The method of claim 1 further comprising the step of:
activating the speech recognition device when there is a match between the acoustic properties of speech which would be expected to be generated by the condition of the speech articulators recorded in the at least one frame of video image with the acoustic properties of speech recorded concurrent with the recording of the at least one video frame.

3. The method of claim 2 further comprising the step of:
maintaining the speech recognition device active for a preset time interval after being activated.

4. The method of claim 3 further comprising the step of:
maintaining the speech recognition device activate beyond the end of the preset time interval upon obtaining a match between the acoustic properties of speech which would be expected to be generated by the condition of the speech articulators recorded in a subsequently recorded frame of a video image with the acoustic properties of speech recorded concurrent with the recording of the subsequently recorded video frame before the fixed period of time expires.

5. The method of claim 1 wherein a camera is used to record the video image of the speech articulators of the user.

6. The method of claim 1 wherein a microphone is used to record the acoustic properties of speech of the user.

7. The method of claim 1 wherein a handheld device contains a microphone for recording the acoustic properties of speech of the user and a camera for recording the video image of speech articulators of the user.

8. A method of controlling the operation of a speech recognition device comprising the steps of:
recording a series of frames of video images of speech articulators of a user while speaking;
recording acoustic properties of speech that occurs concurrent with the recording of each of the series of video frames;
identifying each frame of the series of frames of video images with the acoustic properties of sounds which are obtained concurrent with the recording of the series of video frames;
examining the video frames for a face;
examining the video frames that have a face for a change of the speech articulators of the face;
identifying acoustic properties of speech that would be expected to be generated by a condition of the speech articulator recorded in the video frame that has a changed speech articulator;
identifying the recorded acoustic properties of speech that occurred at the time that the video frame of a face having a change of speech articulators was obtained; and
comparing the identified acoustic properties of speech that occurred at the time that the video frame of a face having a change of speech articulators with the identified acoustic properties that would be expected to be generated to determine whether the speech of the identified acoustic properties emanated from the user.

9. The method of claim 8 further comprising the step of:
activating the speech recognition device when there is a match between the identified acoustic properties of speech that occurred at the time that the video frame of a face having a change of speech articulators with the identified acoustic properties that would be expected to be generated concurrently wit the video frame.

10. The method of claim 9 further comprising the step of:
maintaining the speech recognition device activated for a preset time interval after activating the speech recognition device.

11. The method of claim 10 further comprising the step of:
deactivating the speech recognition device at the end of the preset time interval in the absence of the occurrence of a subsequent match between the identified acoustic properties of speech that occurred at the time that the video frame of a face having a change of speech articulators with the identified acoustic properties that would be expected to be generated concurrently with the video frame.

12. Apparatus for controlling the operation of a speech recognition device comprising;
video means for recording at least one video image of the speech articulators of a user and analyzing the video image to identify the acoustic properties of speech that would be expected to be generated by the condition of the speech articulators;
acoustic means for recording acoustic properties of speech by the user that occur concurrently with the recording of the at least one video image;
comparing means for comparing the acoustic properties of speech that would be expected to be generated by the condition of the speech articulators with the recorded acoustic properties of speech by the user, and
control means to activate the speech recognition device when the comparing means identifies a match.

13. Apparatus according to claim 12 further comprising:
a video signal processing means for analyzing the a least one video image to identify the acoustic properties of speech that would be generated by the condition of the speech articulators.

14. The apparatus of claim 12 wherein the video means is a video camera and the acoustic means is a microphone.

15. The apparatus of claim 14 wherein the video camera and microphone are in a handheld device.

16. An article comprising:
a computer program in a machine readable medium wherein the computer program executes on a suitable platform to control the operation of a speech recognition unit and is operative to automatically analyze at least one video image to detect a change of the speech articulators of the face of a user and generate a characteristic of speech which can be made by the shape of the speech articulators.

17. The article of claim 16 wherein the computer program automatically compares the generated speech with actual speech made at the time that the video image was obtained to determine if the actual speech is the speech of the user at the time that the video image was made.
